(19) United States
(12) Patent Application Publication
(10) Pub. No.: US 2026/0177992 A1
(43) Pub. Date: Jun. 25, 2026

(54) Preference-Guided Optimization Control of Industrial Machines Using Acausal Coactive Acquisition

(71) Applicant: Mitsubishi Electric Research Laboratories, Inc., Cambrige, MA (US)

(72) Inventors: Diego Romeres, Boston, MA (US); Ankush Chakrabarty, Bedford, MA (US); Ketong Shao, Berkeley, CA (US); Joshua Hang Sai Ip, Berkeley, CA (US); Ali Mesbah, Danville, CA (US)

(73) Assignee: Mitsubishi Electric Research Laboratories, Inc., Cambridge, MA (US)

(21) Appl. No.: 18/987,357

(22) Filed: Dec. 19, 2024

(51) Int. Cl. G05B 13/02; G05B 13/04

(52) U.S. Cl. CPC G05B 13/0265; G05B 13/048

(57) ABSTRACT

A method and a system for controlling an industrial machine generate multiple outcomes by optimizing an acausal coactive acquisition function configured to maximize a joint gain in the utility of the generated outcomes according to the trained utility model and a preference of the generated outcomes according to the trained preference outcome model. In response to determining a desired outcome based on the generated outcomes, the system determines the operating parameters of the industrial machine corresponding to the desired outcome; and controls the industrial machine according to the mapped operating parameters.

### TECHNICAL FIELD

The present disclosure relates generally to methods and systems for optimizing and controlling industrial machines. Specifically, it focuses on user-centric, data-driven approaches for multi-objective optimization and performance customization using preference-guided mechanisms. Applications include tuning machine operating parameters for improved efficiency, quality, and user satisfaction in industrial production environments.

### BACKGROUND

The increasing complexity of modern industrial machines has introduced significant challenges in optimizing their operation to meet diverse and often conflicting performance objectives. For instance, machines used in manufacturing must balance trade-offs such as production speed, quality, cost, and energy efficiency. While traditional approaches rely on manual tuning by skilled engineers, this process is time-consuming, costly, and often requires extensive domain expertise.

Moreover, end-users typically lack detailed knowledge of the internal workings of these machines and instead rely on subjective assessments of outcomes to express their preferences. Translating these preferences into actionable adjustments for machine parameters is difficult due to the intricate and interconnected nature of the systems involved. Current methods for resolving these challenges are often inefficient, lack scalability, and fail to account for dynamic user feedback effectively.

Thus, there exists a pressing need for a systematic and automated method that can adaptively optimize machine parameters based on user preferences while minimizing the need for manual intervention. Addressing this need would enable more efficient customization of machine performance to suit specific user requirements, reduce operational costs, and improve overall productivity in industrial settings.

### SUMMARY

Tuning the parameters of a complex industrial machine can be framed as a multi-objective optimization problem, where multiple, often conflicting objectives must be optimized simultaneously. In this context, each parameter setting influences various outcomes, such as accuracy, quality, speed, and cost. These outcomes are typically interconnected, meaning that improving one aspect (e.g., product accuracy) might negatively impact another (e.g., production time or operating cost).

In multi-objective optimization, there is rarely a single optimal solution that simultaneously maximizes all objectives. Instead, there exists a set of “optimal” solutions, known as the Pareto frontier or Pareto front. Each point on the Pareto frontier represents a trade-off where no objective can be improved without degrading at least one other objective. This means there are potentially infinite parameter settings along the Pareto frontier, each achieving a different balance among objectives.

When tuning an industrial machine, finding a solution on the Pareto frontier aligns with selecting parameter settings that balance the conflicting objectives to meet specific needs. For instance, a customer may prioritize product quality and accuracy over speed, placing their desired solution toward one area of the Pareto frontier. However, identifying this specific point is challenging, as it requires navigating the infinite solutions on the Pareto front without full knowledge of the complex interactions between machine parameters and outcome objectives.

This complexity is compounded by the fact that customers often lack the expertise to understand the machine's parameter settings, making it difficult for them to specify the precise trade-offs they prefer. Consequently, an iterative feedback system becomes essential, allowing customers to indicate their desired performance characteristics incrementally. This system can then leverage multi-objective optimization techniques to adjust the parameters in a way that gradually hones in on the point on the Pareto frontier that best aligns with the customer's goals.

To that end, some embodiments disclose a system and a method for adaptively controlling industrial machines by leveraging user preferences to optimize machine performance across multiple objectives. It is an object of these embodiments to overcome challenges caused by the conflicting nature of performance objectives of the industrial machines, such as speed, quality, and cost, and the intricate relationships between these objectives and machine parameters.

The method includes the development and/or use of a utility model that approximates a utility function to quantify the value or benefit of various machine outcomes based on user-defined preferences, and a preference outcome model that maps pairs of machine outcomes to an alternative outcome preferred by the user, capturing nuanced preferences to guide optimization. These models enable an acausal coactive acquisition function allowing to generate multiple outcomes designed to maximize the utility and alignment with user preferences. These outcomes are evaluated to determine a desired outcome that satisfies both user-defined and operational objectives. The desired outcome is then mapped to specific operating parameters of the machine.

The industrial machine is controlled based on these optimized parameters, enabling dynamic adaptation to user preferences while maintaining high performance across multiple objectives. This iterative, feedback-driven process enhances the machine's ability to achieve tailored outcomes, minimizes reliance on manual tuning, and aligns machine performance with specific user requirements effectively and efficiently. This approach provides a scalable and systematic solution to the challenges of multi-objective optimization in industrial machine control, delivering improved customization, reduced operational complexity, and enhanced productivity.

Accordingly, one embodiment discloses a method for controlling an industrial machine, wherein the method uses a processor coupled with stored instructions implementing the method, wherein the instructions, when executed by the processor carry out steps of the method, including collecting a utility model trained to approximate a utility function defining the utility of an outcome of the industrial machine; collecting a preference outcome model trained to map at least a pair of the outcomes of the industrial machine to another outcome preferred over the outcomes of the pair; generating multiple outcomes by optimizing an acausal coactive acquisition function configured to maximize a joint gain in the utility of the generated outcomes according to the trained utility model and a preference of the generated outcomes according to the trained preference outcome model; determining a desired outcome based on the generated outcomes; mapping the desired outcome to the operating parameters of the industrial machine; and controlling the industrial machine according to the mapped operating parameters.

Another embodiment discloses a system for controlling an industrial machine, comprising: a processor; and a memory having instructions stored thereon that, when executed by the processor, cause the system to: collect a utility model trained to approximate a utility function defining the utility of an outcome of the industrial machine; collect a preference outcome model trained to map at least a pair of the outcomes of the industrial machine to another outcome preferred over the outcomes of the pair; generate multiple outcomes by optimizing an acausal coactive acquisition function configured to maximize a joint gain in the utility of the generated outcomes according to the trained utility model and a preference of the generated outcomes according to the trained preference outcome model; determine a desired outcome based on the generated outcomes; map the desired outcome to the operating parameters of the industrial machine; and control the industrial machine according to the mapped operating parameters.

Yet another embodiment discloses a non-transitory computer-readable storage medium embodied thereon a program executable by a processor for performing a method for perceiving an object in a scene, the method including: collecting a utility model trained to approximate a utility function defining the utility of an outcome of the industrial machine; collecting a preference outcome model trained to map at least a pair of the outcomes of the industrial machine to another outcome preferred over the outcomes of the pair; generating multiple outcomes by optimizing an acausal coactive acquisition function configured to maximize a joint gain in the utility of the generated outcomes according to the trained utility model and a preference of the generated outcomes according to the trained preference outcome model; determining a desired outcome based on the generated outcomes; mapping the desired outcome to the operating parameters of the industrial machine; and controlling the industrial machine according to the mapped operating parameters.

### BRIEF DESCRIPTION OF THE DRAWINGS

FIG. 1A illustrates schematics of principles employed by some embodiments for controlling the operation of an industrial machine according to an embodiment of the present disclosure.

FIG. 1B shows a block diagram of a method for controlling industrial machines by optimizing, e.g., interactively, machine parameters based on user preferences according to some embodiments.

FIG. 1C shows a block diagram of a method for learning user preferences according to some embodiments.

FIG. 1D shows a schematic of a method of data mismatch between the optimization variables in the acquisition function and the utility and preference outcomes models addressed by some embodiments.

FIG. 2 shows a schematic of a multi-staged optimization method using a user-centric coactive PGBO (uc-PGBO) framework according to some embodiments.

FIG. 3 shows a pseudo-code of the uc-PGBO algorithm according to some embodiments.

FIG. 4 shows a pseudo-code of implementing an acausal coactive acquisition function as a knowledge-gradient coactive acquisition function allowing zero-shot optimization according to some embodiments.

FIG. 5A shows a schematic of an exemplar third stage of the preference-based optimization process employed by some embodiments.

FIG. 5B shows a pseudo-code of an exemplary implementation of the Gradient Descent Stage according to some embodiments.

FIG. 6 shows a high-level schematic of a preference-based optimization process for controlling an industrial machine employed by some embodiments.

FIG. 7 shows a block diagram illustrating a CNC control system for controlling an NC machine according to some embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

### Definitions

Operating Parameters or Decision Variables: A set of parameters used to control a machine. These parameters represent the adjustable inputs or settings of the machine that various embodiments aim to optimize to achieve desired outcomes.

An Outcome: A set of metrics that define multiple, potentially competing, performance parameters of a machine's operation when executing a task, based on a specific set of operating parameters.

A Surrogate Model or Outcome Model: A probabilistic model trained to replicate the behavior of the machine (e.g., NC machine), using historical data that includes user preferences and prior observations.

A Surrogated Outcome: An estimated outcome generated by the surrogate model rather than being produced directly by the actual machine. It serves as a computationally efficient prediction of machine behavior.

A Query: A set of at least two different outcomes presented for evaluation, typically to elicit user preferences.

A Pairwise Comparison: A feedback mechanism where the user specifies whether they prefer the first or second outcome in a given pair of outcomes.

A Coactive Feedback: A user-suggested outcome that is preferred over the presented outcomes in a query. This feedback embeds domain-specific insights or preferences into the optimization process.

A Preference Outcome Model: A function or model that predicts a user-preferred outcome based on a given query, utilizing pairwise comparisons and coactive feedback to refine predictions.

A Utility Function: A mathematical function that quantifies the value or satisfaction a user derives from a given outcome, based on their specific preferences and objectives.

A Utility Model: A probabilistic model trained to approximate the utility function, using historical data of user preferences and feedback. This model predicts the utility of outcomes to guide optimization.

An Acquisition Function: A mathematical function used to evaluate the usefulness of specific decision variables or outcomes in the context of optimization. It prioritizes exploration of decision spaces to find the most promising outcomes.

A Coactive Acquisition Function (such as Knowledge Gradient Acquisition Function): A specialized acquisition function that evaluates the potential benefit of adding an additional query to maximize the difference between the maximum utility of a model conditioned on the new query and the current utility model without the query.

An Acausal Coactive Acquisition Function (such as Knowledge Gradient Coactive Acquisition Function, KGCAF): Operating Parameters or Decision Variables: A set of parameters used to control a machine. These parameters represent the adjustable inputs or settings of the machine that various embodiments aim to optimize to achieve desired outcomes.

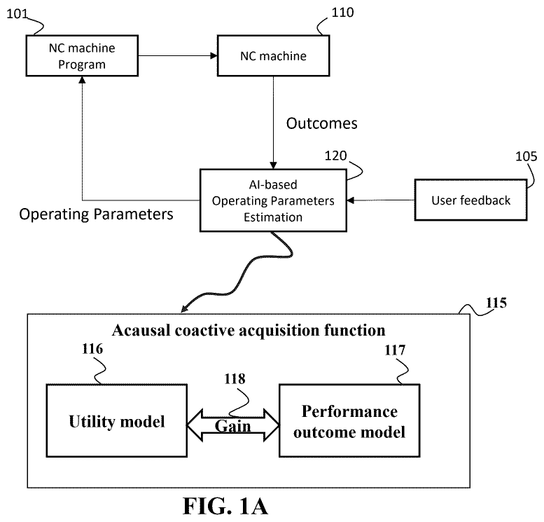

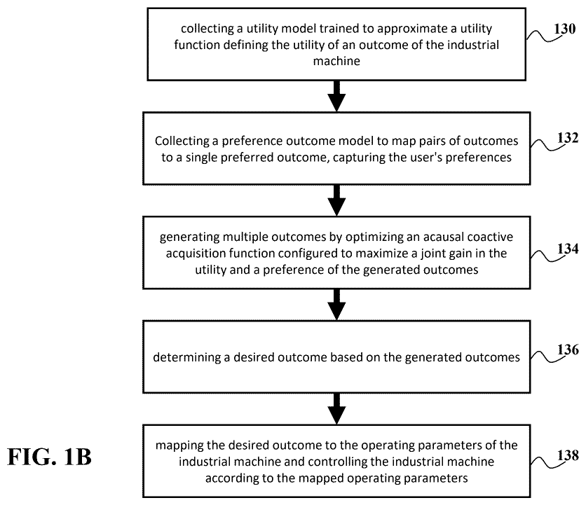

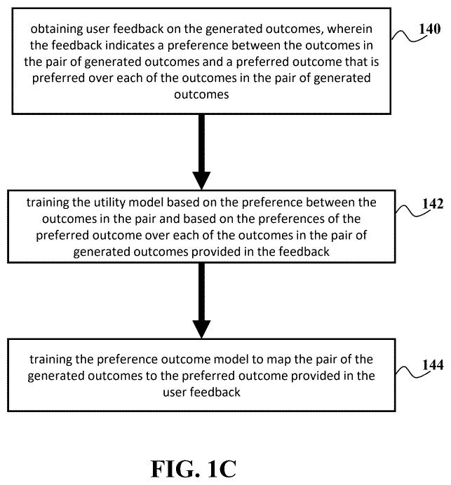

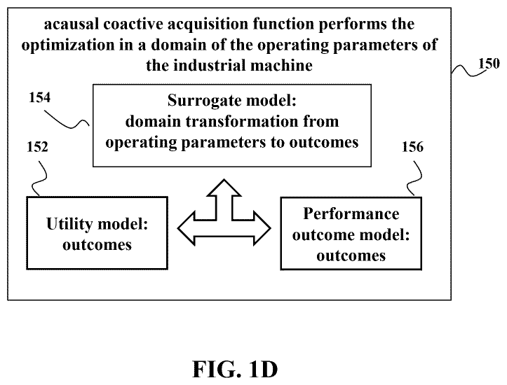

FIG. 1A illustrates schematics of principles employed by some embodiments for controlling an operation of an industrial machine such as a NC machine system 110, according to an embodiment of the present disclosure. The NC machine 110, such as metal cutters, laser cutters, milling machines, and lathes are widely used in industrial applications. The wide applicability of these machines to different industries is leading to the need of customization of the operating parameters of the machine, defined in a NC machine program 101, in an automatic and efficient manner according to the user's preferences. Typically, the users require customized outcomes from the NC machine 110. While users have a good understanding of what the outcome should be they do not fully understand how the NC machine 110 works. Therefore, NC machine producers need to send expert engineers on-site to tune the operating parameters in order to obtain outcomes that satisfy the user. This is costly and not time-efficient.

It is an objective of some embodiments to provide a data-driven approach 120, that considers the user's feedback 105 on the outcomes for determining an optimal combination of operating parameters of the NC machine 110 that modifies the NC program 101 that leads to outcomes of the NC machine 110 that satisfy the user, without using an analytical model of the underlying system or having any prior knowledge on the underlying system.

Motivated by this application some embodiments aim to solve a multi-objective optimization problem, which can be recast into a utility maximization problem as follows:

$${max u ( f ( x ) )}_{x ∈ 𝕏} , \qquad ( 1 )$$

where x∈ [symbol] ⊂ [symbol] ^{d} denote the operating parameters or decision variables. The function ƒ: [symbol] ^{d}→ [symbol] ^{o} represents the multiple objectives to be balanced in the outcomes of the industrial machine; henceforth, ƒ is referred to as the outcome function. Note that this function is assumed to be expensive to evaluate and behaves like a black-box oracle, i.e. it can be evaluated for a given x but we cannot, for example, take gradients of ƒ.

Some embodiments are based on the understanding that certain outcomes are preferred by the user to others, which may be modeled by the utility function u: [symbol] ^{o}→ [symbol] . This function is not always known but can be approximated with noisy observations of the outcome function, that is, yᵢ=ƒ(xᵢ)+∈, where ∈ models Gaussian noise, independent of ƒ, with variance

$${σ}_{ϵ}^{2}$$

Iₒ where I is the o×o identity matrix. Due to the black-box noisy nature of the problem, some embodiments solve (1) using concepts from Bassian Optimization (BO), and refer to the proposed procedure as preference-guided BO (PGBO).

In some embodiments, the data-driven approach 120 is implemented using acausal coactive acquisition function 115 including a utility model 116 trained to approximate a utility function defining the utility of an outcome of the industrial machine, and a preference outcome model 117 trained to map at least a pair of the outcomes of the industrial machine to another outcome preferred over the outcomes of the pair. Having these two models allows for joint optimization leading to maximizing a joint gain 118 to consider both the utility of the outcomes and user-preference of the outcomes.

This approach offers a holistic optimization framework that seamlessly integrates objective performance metrics with subjective user preferences. By combining a utility model to quantify the value of machine outcomes and a preference outcome model to map user-defined priorities, the system ensures that industrial machines deliver results tailored to operational needs and user expectations. The joint optimization of utility and preference allows the system to navigate complex trade-offs, such as balancing speed, cost, and quality, with precision and efficiency. This user-centric design empowers operators by dynamically incorporating feedback, reducing the need for manual tuning, and enabling adaptive machine performance that evolves in real-time with changing requirements.

Additionally, this method significantly enhances decision-making and operational efficiency by prioritizing impactful adjustments. The system reduces the computational burden of optimization through intelligent exploration and exploitation, allowing faster convergence to optimal settings while minimizing redundant experimentation. By aligning machine behavior with user-defined goals, it improves user satisfaction and fosters confidence in automated optimization processes. Its scalability makes it applicable to diverse industries and scenarios, from precision manufacturing to energy-efficient operations, delivering a transformative combination of productivity, adaptability, and resource efficiency.

In some embodiments, the gain 118 to be maximized by the acausal coactive acquisition function 115 a difference between the utility of the utility model 116 and the utility of the utility model 116 tuned based on the utility of the pair of outcomes and a prediction of the preferred outcome given by the preference outcome model 117. This approach ensures that the system prioritizes optimization steps that provide the most informative and impactful adjustments to the utility model. By focusing on maximizing the difference (or “gain”), the system effectively hones in on regions of the parameter space that yield the greatest improvement in outcomes, as defined by both user preferences and operational utility.

However, alternative embodiments can use different definitions of the gain maximizing the informativeness of the outcome. For example, an alternative definition of the gain could focus on maximizing the expected information gain from the inclusion of new feedback in both the utility model and the preference outcome model. This alternative approach not only considers the difference in utility but also incorporates the uncertainty reduction and the model improvement resulting from the feedback.

An alternative definition of the gain focuses on maximizing the expected information gain by incorporating both utility improvement and uncertainty reduction into the optimization process. This approach defines the gain as the combination of the difference in predicted maximum utility of the utility model before and after being updated with feedback and the reduction in uncertainty across both the utility model and the preference outcome model. By integrating the impact of uncertainty reduction, this alternative gain ensures that feedback not only improves immediate utility but also enhances the models' predictive accuracy for future iterations. It prioritizes adjustments that provide the most informative updates, balancing exploration of new parameter spaces with exploitation of known high-performing regions. This leads to more robust optimization, faster convergence to globally optimal solutions, and more impactful iterations by making every piece of feedback count toward improving the models' understanding of both utility and preferences.

FIG. 1B shows a block diagram of a method for controlling industrial machines by optimizing, e.g., interactively, machine parameters based on user preferences according to some embodiments. Industrial machines often operate under diverse conditions, requiring precise tuning to meet varying user requirements. However, this tuning process is complicated by conflicting performance objectives such as accuracy, speed, quality, and cost. The relationships between machine parameters and outcomes are intricate, making it difficult for users-who often lack technical expertise—to specify their preferences or trade-offs effectively. Traditional methods of manually tuning machines or using fixed optimization techniques are inefficient, time-consuming, and fail to dynamically account for evolving user preferences.

To address this challenge, one embodiment introduces a method for controlling industrial machines through a dynamic, user-centric optimization process. The method includes collecting 130 a utility model, which is trained to approximate a utility function that quantifies the value of various machine outcomes based on user preferences. In addition, a preference outcome model is collected 132 to map pairs of outcomes to a single preferred outcome, capturing the user's nuanced preferences and trade-offs.

The method leverages an acausal coactive acquisition function to generate 134 multiple outcomes by balancing the joint gain in utility and preference alignment. This acquisition function predicts the impact of potential outcomes on user satisfaction, enabling the system to generate more informative queries and focus the optimization process on solutions that align with the user's priorities.

Once these outcomes are generated, the method determines a desired outcome 136 that best meets the user's goals. This desired outcome is then mapped 138 to specific operating parameters of the industrial machine, which is subsequently controlled according to these parameters. By iteratively refining the utility and preference models based on user feedback, the system dynamically adapts to evolving preferences, ensuring that the machine delivers tailored performance with minimal manual intervention.

In some embodiments, the acausal coactive acquisition function returns the utility of the pair of outcomes maximizing a difference between the utility of the utility model and the utility of the utility model tuned based on the utility of the pair of outcomes and a prediction of the preferred outcome given by the preference outcome model. The acausal coactive acquisition function evaluates the usefulness of an additional query by measuring the difference between the maximum utility of an updated utility model (after incorporating the query) and the current utility model. By explicitly factoring in the predicted preferred outcome from the preference outcome model, the function ensures that new queries maximize information gain, leading to faster convergence toward optimal solutions.

The preference outcome model integrates user feedback to predict preferred outcomes from a query. By leveraging these predictions, the acausal coactive acquisition function can anticipate how new outcomes will align with user preferences before presenting them to the user. This allows the optimization process to focus on outcomes that are more likely to satisfy the user, improving the efficiency of feedback collection and reducing redundant queries. As a result, the acausal coactive acquisition function enhanced by the preference outcome model improves the efficiency, adaptability, and accuracy of multi-objective optimization. It accelerates convergence to user-preferred solutions, reduces the computational burden of optimization, and ensures outcomes are tailored to nuanced user preferences. This capability is particularly beneficial in industrial machine control, where optimizing performance across multiple conflicting objectives is critical.

This method is guided by the insight that user preferences are best elicited iteratively rather than requiring explicit knowledge of machine parameters. To that end, some embodiments iteratively learn user preferences and tune the operating parameters of the industrial machine based on user feedback from a user interface.

The utility and preferred outcome models enable the system to systematically incorporate user preferences, while the acquisition function accelerates convergence by focusing on the most informative queries. The iterative feedback loop effectively navigates the Pareto frontier of multi-objective optimization, identifying parameter settings that balance competing objectives.

The proposed solution offers significant technical advantages. By personalizing optimization to specific user needs, it improves efficiency and reduces reliance on manual tuning. The use of the acausal coactive acquisition function enhances decision-making, enabling faster identification of optimal solutions. Furthermore, the system's scalability makes it suitable for a wide range of industrial applications, delivering cost and time savings by minimizing downtime and reducing the need for on-site engineers.

FIG. 1C shows a block diagram of a method for learning user preferences according to some embodiments. The embodiment includes obtaining 140 user feedback on the generated outcomes, wherein the feedback indicates a preference between the outcomes in the pair of generated outcomes and a preferred outcome that is preferred over each of the outcomes in the pair of generated outcomes. Using this feedback, the embodiment includes training 142 the utility model based on the preference between the outcomes in the pair and based on the preferences of the preferred outcome over each of the outcomes in the pair of generated outcomes provided in the feedback, and training 144 the preference outcome model to map the pair of the generated outcomes to the preferred outcome provided in the user feedback.

The method of FIG. 1C outlines a user-centric approach to optimizing industrial machines by learning and adapting to user preferences. It begins by presenting the user with a pair of outcomes generated by the system. The user provides feedback on these outcomes in two forms: a preference for one outcome over the other and a suggested outcome they prefer over both. This dual feedback mechanism captures not only explicit comparisons but also implicit insights into the user's ideal outcome.

Using this feedback, the system refines two models. The first is the utility model, which is trained to approximate how much value or utility a user derives from different outcomes. By incorporating pairwise preferences and suggestions, the utility model becomes more accurate at predicting which outcomes will satisfy the user. The second is the preference outcome model, which maps pairs of outcomes to the preferred outcome provided by the user. This model helps anticipate future user preferences, enabling the system to propose outcomes that are increasingly aligned with the user's goals.

In some implementations, the embodiments iteratively repeat learning user preferences and tuning the operating parameters in successive cycles until a termination condition is met to update the models and generate outcomes that progressively align with the learned user preferences. After updating the models, the system adjusts the machine's operating parameters and generates new outcomes. These outcomes are presented to the user for feedback, and the cycle repeats. This iterative approach ensures that the machine's performance progressively aligns with the user's evolving preferences. The process continues until a predefined termination condition is met, such as achieving an optimal solution or exhausting a budget for iterations.

By dynamically adapting to user feedback, this method enables efficient, personalized optimization. It reduces the need for manual intervention and allows users to achieve tailored machine performance, even when their preferences are complex or difficult to articulate explicitly. This narrative showcases how user input, combined with advanced modeling, drives a continuously improving, feedback-driven system.

FIG. 1D shows a schematic of a method of data mismatch between the utility and preference outcomes models addressed by some embodiments. In some implementations, the acausal coactive acquisition function performs 150 the optimization in a domain of the operating parameters of the industrial machine. While the utility model operates in the domain 152 of the outcomes of the industrial machine, and the preference outcome model also operates 156 in the domain of the outcomes of the industrial machine. To address this problem, the acausal coactive acquisition function transforms 154 the operating parameters into domain of the outcomes using a surrogate model of the industrial machine.

This solution addresses the mismatch between the utility model, the preference outcome model and the acquisition function that operate in different domains. Specifically, the utility model evaluates machine performance in the domain of machine outcomes, the preference outcome model operates in the domain of machine outcomes and the acausal coactive acquisition function optimizes in the domain of the operating parameters. This disparity can complicate the optimization process, as the models collaborate to identify optimal machine configurations effectively within the optimization of the acquisition function.

To resolve this, the method employs a surrogate model of the industrial machine that bridges the gap between these domains. The preference outcome model provides insights into user preferences for specific outcomes, but these outputs are in the outcome domain, not directly linked to machine operating parameters. To make this information actionable, the acquisition function uses a surrogate model of the industrial machine to transform the operating parameters into the domain of the outcomes, then guide the optimization with the aid of the utility model and preference outcome model to obtain optimal operating parameters.

The implementation of this process as a knowledge-gradient coactive acquisition function (KGCAF) provides further advantages by enabling one-shot optimization. KGCAF effectively prioritizes the most informative queries, reducing the need for iterative and computationally expensive evaluations. It optimizes within the operating parameter domain while incorporating user preferences predicted in the outcome domain, ensuring that the system learns and converges efficiently.

To enable this performance, some embodiments use a surrogate model as a simplified representation of a complex system, designed to approximate its behavior in a way that is much faster and more efficient to compute. When dealing with systems like industrial machines, where direct evaluations of outcomes for various parameter settings can be computationally expensive or time-consuming, surrogate models offer a practical solution. These models act as stand-ins, predicting the system's outputs based on its inputs, enabling optimization and analysis without the need to repeatedly test the actual machine.

Some embodiments are based on recognizing that in the context of optimizing industrial machines, a surrogate model can bridge the gap between different domains, such as simulating operating parameters into desired outcomes. For example, user feedback often expresses preferences in terms of the outcomes they wish to see-like higher accuracy or lower cost—while the machine operates in a domain defined by specific parameter settings. The surrogate model links these two domains by predicting how a given set of operating parameters will translate into machine outcomes.

This capability allows the system to incorporate user preferences into the optimization process effectively. Rather than requiring direct and costly experiments with the machine for every iteration, the surrogate model provides a computationally efficient way to simulate the machine's behavior. It can be updated with new data over time, improving its accuracy and ensuring it remains a reliable tool for optimization.

Surrogate models can take various forms, from simple regression models that establish relationships between inputs and outputs, to advanced machine learning models like Gaussian processes or neural networks that capture complex patterns in the data. By offering a fast and accurate approximation of the system, they enable iterative processes like optimization to converge more quickly and with fewer resources.

In essence, the surrogate model empowers the optimization process by providing a fast, adaptable, and cost-effective way to explore the vast space of possible solutions. It ensures that the system can dynamically respond to user feedback, refining both the optimization process and the machine's performance to deliver outcomes that align with user goals efficiently and effectively.

Some embodiments are based on the insight that the utility model, preference outcome model, and surrogate model can be independently trained during different stages of the same optimization process, yet seamlessly integrated into a unified solution when needed. This approach enables the models to specialize and refine their roles while ensuring compatibility and synergy within the overall system. By structuring the optimization process in this way, the method allows for rapid deployment across a wide range of industrial applications, offering flexibility, scalability, and efficiency in adapting to diverse operational requirements.

To that end, in some embodiments, an iteration of the method includes a preference-guided exploration (PGE) stage for learning user preferences for the desired outcome and an experimentation (EXP) stage for training a surrogate model of the industrial machine utilized in the PGE stage. During the EXP stage, the method includes determining EXP operating parameters of the machine using a probabilistic acquisition function employing the utility model; performing one or a combination of simulating or operating the industrial machine according to the EXP operating parameters to produce an EXP outcome of the machine operated according to the EXP operating parameters; and training the surrogate model of the machine using a pair of the EXP operating parameters and the EXP outcome.

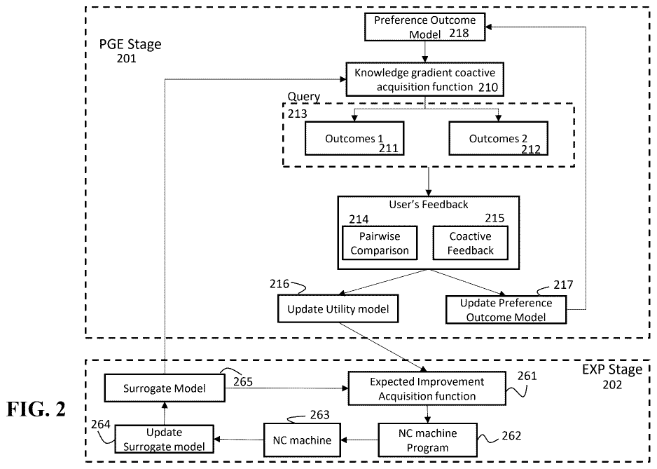

FIG. 2 shows a multi-staged optimization method using a user-centric coactive PGBO (uc-PGBO) framework according to some embodiments. The embodiments use a two-stage iterative method that alternates the preference-guided exploration (PGE) 201, and the experimentation (EXP) stage 202.

The PGE Stage 201 is designed to efficiently gather information about the user's preferences by generating outcomes that will lead to a more accurate approximation of the true utility function. Specifically, the PGE stage involves maximizing our proposed knowledge-gradient co-active acquisition function (KGCAF) 210 for M∈ [symbol] times. For the m-th iteration, the maximization procedure yields a pair of outcomes {(y_{1,m}, y_{2,m})} 211 and 212; this is done for m=1, . . . , M. At each iteration, the outcome pair, called query 213, is first presented to the user, who is asked to provide preferential feedback, which has two components: (i) a pairwise comparison 214 rₘ: =r(y_{1,m}, y_{2,m})={1,2} that indicates whether the user prefers the first or second outcome on each pair; (ii) a coactive feedback 215 component y_{3,m}, which is a suggested outcome vector that they prefer over the observed (y_{1,m}, y_{2,m}). This coactive feedback is valuable because it embeds domain knowledge that the user possesses, and ideally provides a good direction for the algorithm to pursue in order to obtain better utility models in subsequent iterations.

Mathematically, assume that u(y₃)≥max{u(y₁), u(y₂)}, which means that the coactive feedback since it proposed by the user, it has higher utility than the outcomes 211 and 212. Once these two components of feedback are acquired, the embodiments update (i) the utility model û(·) 216 that learns a latent function incorporating the preference information between a pair and its corresponding pairwise preference {(y_{1,m}, y_{2,m}), rₘ} and the two additional pairs obtained freely from the coactive feedback {(y_{3,m}, y_{1,m}),1}, {(y_{3,m}, y_{2,m}),1}; and (ii) the preference outcome model h( [symbol] ) 218 that maps a pair(y_{1,m}) y_{2,m}) to a user-preferred outcome y_{3,m}.

Some embodiments are based on the understanding that the coactive feedback y₃ can be used to improve the utility model, without explicitly accounting for a preference outcome model h 218. However, in various embodiments, the coactive feedback y₃ is explicitly used to update h, which in turn embeds preference information into the maximization of the KGCAF 210;

therefore the maximizer of the KGCAF (especially in later iterations of the PGE stage) will yield outcome pairs that should be strongly preferred by the user. By collecting this ‘more informative’ preference data, embodiments rresult infaster convergence to a preferred candidate as opposed to prior work which does not explicitly model h and relies only on u.

In the EXP Stage 202 some embodiments aim to obtain decision variables x that result in high utility values, ideally converging to the optimal utility, which means decision variables that generate the optimal outcome that satisfies the user. To this end, the true outcome function ƒ 263, representing for example the NC machine, is approximated by a probabilistic surrogate model, denoted \hat{ƒ} 265. The embodiments use the surrogate model \hat{ƒ} in order to maximize the batch version of the noisy expected improvement under utility uncertainty (qEIUU) 261, which results in N set of decision variables {x}_{1:N}. This decision variables are then passed to the actual outcome function ƒ through the NC machine program 263, to obtain the corresponding actual outcome vector y_{1:N}. The surrogate model 265 is then updated in 264 using as training data the pairs (x_{1:N}, y_{1:N}).

In the uc-PGBO, the PGE 201 and EXP 202 stages can be used alternatively repeated for a finite number of budgeted Q iterations. Finally, the user may select their preferred outcome and its corresponding set of decision variables.

To improve the operations, some embodiments approximate the outcome function ƒ as the surrogate model, the utility function u as the utility model and the preference outcome h as the preference outcome model using various probabilistic representations. For example, Gaussian Process (GP) Regression is a common probabilistic method adopted in BO frameworks for its adaptability, data efficiency and uncertainty estimation.

Surrogate model: Each objective in the outcomes function ƒ is modeled with an independent GP ƒ^{a}(·)˜ [symbol] (m^{a}(·), k^{a}(·,x′), ∀a∈1, . . . , 0, where m^{a} is the prior mean value usually set to 0 and k^{a} is the prior covariance, called kernel function. During the q-th iteration of the EXP stage the dataset containing the decision variables and the associated outcomes is updated

$${𝒟}^{a} = {𝒟}^{a} ⋃ {\{ ( {x}_{i} , {y}_{i}^{a} ) \}}_{i = 1}^{N} = \{ X , {y}^{a} \} ,$$

∀a∈1, . . . , o, where y^{a}=ƒ^{a} (x)+∈, and used as a training dataset to train ƒ^{a}. The posterior estimate at a new decision variable x* becomes \hat{ƒ}^{a}˜ [symbol] (μ^{a}(x*),Σ^{a} (x*)):

$${μ}^{a} ( {x}^{*} ) = {m}^{a} ( {x}^{*} ) + {k}_{n}^{a} ( {x}^{*} ) {( {K}_{n}^{a} + {( {σ}_{ϵ}^{a} )}^{2} {I}_{n} )}^{- 1} {y}^{a} , \qquad ( 2 )$$

$${\sum }^{a} ( {x}^{*} ) = {k}^{a} ( {x}^{*} , {x}^{*} ) - {k}_{n}^{a} ( {x}^{*} ) {( {K}_{n}^{a} + {( {σ}_{ϵ}^{a} )}^{2} {I}_{n} )}^{- 1} {{k}_{n}^{a} ( {x}^{*} )}^{⊤}$$

Here,

$${k}_{n}^{a} ( {x}^{*} ) = [ {k}^{a} ( {x}^{*} , {x}_{1} ) , … , {k}^{a} ( {x}^{*} , {x}_{n} ) ]$$

contains the covariances between the new decision variable x* and the training points, Iₙ is a n×n identity matrix, and

$${K}_{n}^{a}$$

is a n×n matrix whose elements are given by

$${[ {K}_{n}^{a} ]}_{i , j} = {k}^{a} ( {x}_{i} , {x}_{j} ) ,$$

∀i, j∈{1, . . . , n}.

Utility model: The latent utility function u is challenging to learn in an analogous way because it is difficult to assign a numerical score of the user preference. Therefore, methods based on relative information are proposed in literature. In this work, u is modeled by a pairwise GP, û, and estimated by observing the results of m user's pairwise and coactive feedback,

$${𝒫}_{m}^{c} = {\{ ( {y}_{1 , j} , {y}_{2 , j} , r ( {y}_{1 , j} , {y}_{2 , j} ) ) , ( {y}_{3 , j} , {y}_{1 , j} , r = 1 ) , ( {y}_{3 , j} , {y}_{2 , j} , r = 1 ) \}}_{j = 1}^{m}$$

at each iteration of the PGE stage. Following [10], we assume that the pairwise comparisons r(y₁, y₂) follow a probit likelihood of the form

$$ℙ ( r ( {y}_{1} , {y}_{2} ) = 1 \vert u ( {y}_{1} ) , u ( {y}_{2} ) ) = Φ ( \frac{u ( {y}_{1} ) - u ( {y}_{2} )}{\sqrt{2} λ} ) , \qquad ( 3 )$$

where λ∈ [symbol] is an hyperparameter and Φ is the standard normal Cumulative Distribution Function CDF. Under this assumption, and given the training dataset

$${𝒫}_{m}^{c}$$

the posterior distribution of the utility function is given by:

$$ℙ ( u \vert {𝒫}_{m} ) ∝ ℙ ( u ) {\prod }_{j = 1}^{m} ℙ ( {y}_{j , p} ≻ {y}_{j , n p} \vert u ( {y}_{j , p} ) , u ( {y}_{j , n p} ) ) \qquad ( 4 )$$

where y_{j,p} indicates the preferred outcome over the non preferred y_{j,np}. This posterior can be approximated to a Gaussian distribution by either Laplace approximation or by variational inference

Preference outcome model: The outcome preference of the user, h: [symbol] ^{2o}→ [symbol] ^{o} that maps a pair(y₁, y₂) into a user-preferred outcome ŷ₃, is modeled using GP Regression similarly to ƒ. The model, ĥ, is trained at each iteration of the PGE stage using the training dataset

$${𝒬}_{m} = {\{ ( ( {y}_{1 , j} , {y}_{2 , j} ) , {y}_{3 , j} ) , ( ( {y}_{2 , j} , {y}_{1 , j} ) , {y}_{3 , j} ) \}}_{j = 1}^{m}$$

after m coactive feedback, which leverages the interchangeability of y₁ and y₂.

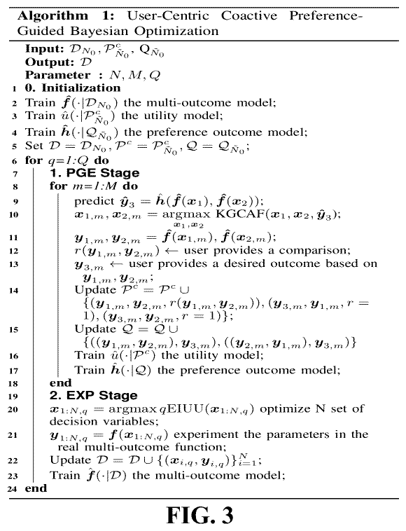

FIG. 3 shows a pseudo-code of the uc-PGBO algorithm according to some embodiments. At the beginning of the procedure

$${X}_{{N}_{0}} = {\{ ( {x}_{i} ) \}}_{i = 1}^{{N}_{0}}$$

decision variables are sampled. Accordingly to the application and the user expertise, if prior knowledge is available X_{N}_{₀} can be sampled from a prior distribution else it can be uniformly sampled in [symbol] . Given X_{N}_{₀} the true outcome function ƒ is

$${𝒟}_{{N}_{0}} = {\{ ( {x}_{i} , {y}_{i} ) \}}_{i = 1}^{{N}_{0}} .$$

evaluated to generate noisy observation that create the dataset From this dataset we generate Ñ₀ random pairs and ask the user for the pairwise preference

$${𝒫}_{{\tilde{N}}_{0}}^{c} = {\{ ( {y}_{1 , j} , {y}_{2 , j} , r ( {y}_{1 , j} , {y}_{2 , j} ) ) , ( {y}_{3 , j} , {y}_{1 , j} , r = 1 ) , ( {y}_{3 , j} , {y}_{2 , j} , r = 1 ) \}}_{j = 1}^{{\tilde{N}}_{0}}$$

and the coactive feedback

$${𝒬}_{{\tilde{N}}_{o}} = {\{ ( ( {y}_{1 , j} , {y}_{2 , j} ) , {y}_{3 , j} ) , ( ( {y}_{2 , j} , {y}_{1 , j} ) , {y}_{3 , j} ) \}}_{j = 1}^{{\tilde{N}}_{o}} .$$

Then, the outcome model \hat{ƒ}, the utility model û and the preference model ĥ are trained on each respective dataset. The number of BO loops, Q, the number of iterations within each PGE stage, M, and the number of optimal decision variables, N, generated in the EXP stage are defined as parameters. Subsequently, the PGE and EXP stage are alternated for Q BO loops and the algorithm outputs a dataset D with the optimal decision variables and associated optimal outcomes that the user can choose from.

### Knowledge-Gradient Coactive Acquisition Function

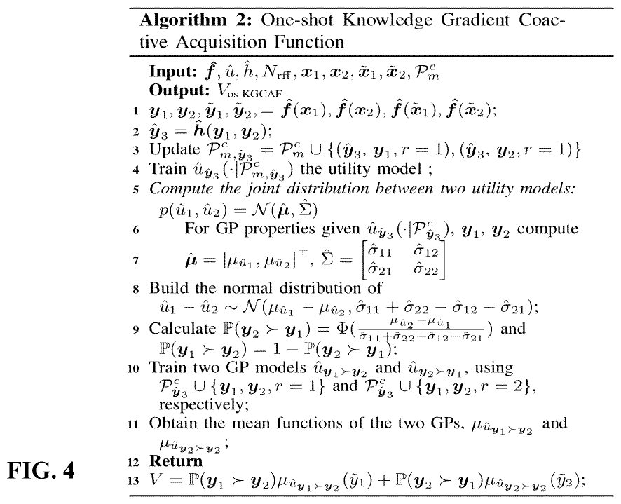

FIG. 4 shows a pseudo-code of implementing an acausal coactive acquisition function as a Knowledge-gradient Coactive Acquisition function allowing zero-shot optimization according to some embodiments. First let's consider the classical knowledge gradient acquisition function which tries to maximize the information gain resulting from the addition of another data point—in our case by providing an outcome vector pair—by accounting for the difference in current utility model and the utility equipped with the additional data point. More rigorously, this will result in the acquisition function (AF) of the form:

$${V}_{K G} ( {y}_{1} , {y}_{2} ) = 𝔼 [ {max}_{y ∈ 𝒴} 𝔼 [ u ( y ) \vert {𝒫}_{m} ⋃ \{ ( {y}_{1} , {y}_{2} , r ( {y}_{1} , {y}_{2} ) ) \} ] - {max}_{y ∈ 𝒴} 𝔼 ( u ( y ) \vert {𝒫}_{m} ] \vert {𝒫}_{m} ] ,$$

where [symbol] ⊂ [symbol] ° is the range of ƒ and

$${𝒫}_{m} = {\{ ( {y}_{1 , j} , {y}_{2 , j} , r ( {y}_{1 , j} , {y}_{2 , j} ) ) \}}_{j = 1}^{m}$$

is the dataset equivalent to

$${𝒫}_{m}^{c}$$

when there is no coactive feedback. Owing to the computational complexity of evaluating, and therefore maximizing V_{KG}, some embodiments proposed the Expected Utility Bayesian Optimization (EUBO) approximation:

$$EUBO ( {y}_{1} , {y}_{2} ) = 𝔼 [ max \{ u ( {y}_{1} ) , u ( {y}_{2} ) \} \vert {𝒫}_{m} ] . \qquad ( 5 )$$

Optimizing (5) is as useful as maximizing V_{KG}, but can be executed efficiently. In eq. (5), the expectation is based on the posterior of û. EUBO is designed for users' pairwise comparison 214, thus is not suitable for handling users' coactive feedback 215. To solve this, some embodiments use the knowledge gradient coactive acquisition function (KGCAF)

$${V}_{KGCAF} ( {y}_{1} , {y}_{2} ) = 𝔼 [ {max}_{y ∈ 𝒴} 𝔼 [ u ( y ) \vert {𝒫}_{m + 1}^{c} ] - {max}_{y ∈ 𝒴} 𝔼 ( u ( y ) \vert {𝒫}_{m}^{c} ] \vert {𝒫}_{m}^{c} ] ≡ 𝔼 [ {max}_{y ∈ 𝒴} 𝔼 [ u ( y ) \vert {𝒫}_{m + 1}^{c} ] ] = {\sum }_{i = 1}^{2} ℙ ( r ( {y}_{1} , {y}_{2} ) = i \vert {𝒫}_{m , {y}_{3}}^{c} ) {max}_{y ∈ 𝒴} 𝔼 [ u ( y ) \vert {𝒫}_{m + 1}^{c} ] . \qquad ( 6 )$$

where

$${𝒫}_{m , {y}_{3}}^{c} = {𝒫}_{m}^{c} ⋃ ( {y}_{3} , {y}_{1} , r = 1 ) ,$$

(y₃, y₂,r=1) and the equivalence symbols in (6) means that the two expressions are equivalent during optimization since the term

$${max}_{y ∈ 𝒴} 𝔼 [ u ( y ) \vert {𝒫}_{m}^{c} ]$$

is independent of the optimization variables y₁, y₂.

KGCAF aims to determine the optimal manner to anticipate and maximize the difference in (expected) maximum utility before and after the preference between y₁ and y₂ is disclosed, given a potentially better alternative y₃. Nonetheless, this acquisition function encounters two primary complications. First, KGCAF is acausal as it uses future information as y₃ and initially the comparative advantage of y₃ over y₁ and y₂ remains unspecified. Secondly, the maximization process entailed by KGCAF involves a nested optimization routine that can become exceedingly lengthy, which may render KGCAF impracticable for operational use.

The first complication can be mitigated by the integration of the data-driven preference outcome model h 218, which is capable of predicting ŷ₃ based on y₁ and y₂. The rationale for employing a data-driven surrogate to estimate 3 is twofold. On one hand, although the initial predictions for ŷ₃ might not be highly precise, the dataset [symbol] is expected to expand with successive BO iterations, thereby refining the model's performance. Moreover, in the early phases, the scarcity of data also means that the trained Gaussian Processes ŷ and û may not be very accurate. On the other hand, if there exists a user-preferred alternative y₃ that is superior in utility, it is typically unattainable-situated beyond the actual Pareto frontier. Consequently, provided that the modeled h function is capable of mimicking this tendency and can anticipate ŷ₃ to fall within the unattainable zone beyond the Pareto frontier, the updated û is more likely to acquire additional insights around the Pareto frontier, which is where the true optimal solution is presumably located.

To streamline the nested optimization process inherent to KGCAF, the embodiments adopt a one-shot approximation, named os-KGCAF, applied to the knowledge gradient coactive acquisition function. That lead to solving the following maximization of the approximated AF of the forₘ:

$${V}_{os - KGCAF}^{*} = {max}_{{y}_{1} , {y}_{2} , {\tilde{y}}_{1} , {\tilde{y}}_{2} ∈ 𝒴} {V}_{os - KGCAF} ( {y}_{1} , {y}_{2} , {\tilde{y}}_{1} , {\tilde{y}}_{2} ) , \qquad ( 7 )$$

$$where$$

$${V}_{os - KGCAF} = ℙ ( r = 1 \vert {𝒫}_{m , {\hat{y}}_{3}}^{c} ) 𝔼 [ u ( {\tilde{y}}_{1} ) \vert {𝒫}_{m}^{c} ⋃ \{ ( {y}_{1} , {y}_{2} , r = 1 ) , ( {\hat{y}}_{3} , {y}_{1} , r = 1 ) , ( {\hat{y}}_{3} , {y}_{2} , r = 1 ) \} ] + ℙ ( r = 2 \vert {𝒫}_{m , {\hat{y}}_{3}}^{c} ) 𝔼 [ u ( {\tilde{y}}_{2} ) \vert {𝒫}_{m}^{c} ⋃ \{ ( {y}_{1} , {y}_{2} , r = 2 ) , ( {\hat{y}}_{3} , {y}_{1} , r = 1 ) , ( {\hat{y}}_{3} , {y}_{2} , r = 1 ) \} ] , \qquad ( 8 )$$

$$where {𝒫}_{m , {\hat{y}}_{3}}^{c} = {𝒫}_{m}^{c} ⋃ \{ ( {\hat{y}}_{3} , {y}_{1} , r = 1 ) , ( {\hat{y}}_{3} , {y}_{2} , r = 1 ) \} .$$

At the cost of adding two more optimization variables \tilde{y}₁, \tilde{y}₂ the approximation os-KGCAF (8) can be computed with only one maximization without solving computationally expensive inner optimizations.

Indeed, within the knowledge gradient framework, the expected maximum of the updated mean function given x is estimated by initially drawing B samples of \hat{ƒ} (x) from the existing Gaussian Process [symbol] . Subsequently, for each B sample, a new [symbol] is trained. This allows for the maximization of the mean function, and the mean of these maximum values across all B samples is calculated. Consequently, this necessitates B separate inner optimizations. To circumvent this extensive computation, B auxiliary decision variables \tilde{x} are introduced. These variables are optimized concurrently with the primary decision variable x, with the aim of optimizing the knowledge gradient acquisition function.

In the context of KGCAF, sampling the utility function values for y₁ and y₂ proves to be redundant, as the focus is primarily on the preference between the two. Consequently, only two scenarios are of interest: either y₁ is preferred over y₂ or vice versa. Therefore, rather than requiring B inner optimizations, KGCAF necessitates merely 2 such optimizations. This implies that for the application of the one-shot approximation, just two auxiliary variables, \tilde{y}₁ and \tilde{y}₂, are essential. This premise leads to the following consideration

$${V}^{*} = {max}_{{y}_{1} , {y}_{2} ∈ 𝒴} {V}_{KGCAF} ( {y}_{1} , {y}_{2} ) = {max}_{{y}_{1} , {y}_{2} ∈ 𝒴} ( ℙ ( r = 1 \vert {𝒫}_{{\hat{y}}_{3}}^{c} ) {max}_{{\tilde{y}}_{1} ∈ 𝒴} 𝔼 [ u ( {\tilde{y}}_{1} ) \vert {𝒫}^{c} ⋃ \{ ( {y}_{1} , {y}_{2} , r = 1 ) , ( {\hat{y}}_{3} , {y}_{1} , r = 1 ) , ( {\hat{y}}_{3} , {y}_{2} , r = 1 ) \} ] + {ℙ}^{c} ( r = 2 \vert {𝒫}_{{\hat{y}}_{3}}^{c} {max}_{{\tilde{y}}_{2} ∈ 𝒴} 𝔼 [ u ( {\tilde{y}}_{2} ) \vert {𝒫}^{c} ⋃ \{ ( {y}_{1} , {y}_{2} , r = 2 ) , ( {\hat{y}}_{3} , {y}_{1} , r = 1 ) , ( {\hat{y}}_{3} , {y}_{2} , r = 1 ) \} ] ) \approx {max}_{{y}_{1} , {y}_{2} , {\tilde{y}}_{1} , {\tilde{y}}_{2} ∈ 𝒴} {V}_{os - KGCAF} ( {y}_{1} , {y}_{2} , {\tilde{y}}_{1} , {\tilde{y}}_{2} ) . \qquad ( 9 )$$

Therefore os-KGCAF is a computationally tractable approximation of the maximum value of the KGCAF. The computation of the os-KGCAF is described in Algorithm 2 in FIG. 4. The computation of the os-KGCAF can replace the computation of the KGCAF in the proposed uc-PGBO framework at Step 11 in Algorithm 1 (FIG. 3).

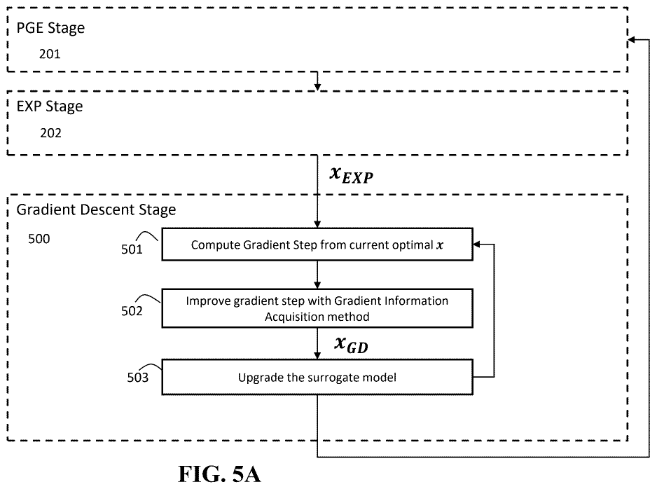

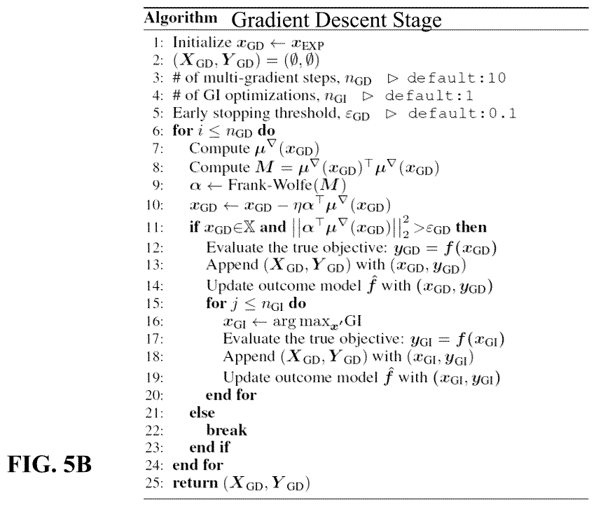

FIG. 5A shows a schematic of an exemplar third stage of the preference-based optimization process employed by some embodiments. This stage is referred to herein as the “Gradient Descent Stage” 500, to further enhance the optimization process. This stage addresses limitations in the existing method by improving upon the solution x_{EXP} produced by the first two stages. While the PGE stage 201 and/or the EXP stage 202 primarily focus on optimizing user satisfaction, this does not always guarantee convergence to the best possible solutions, particularly under conditions of uncertainty. As a result, the final operating parameters often miss opportunities for further performance improvement.

The Gradient Descent Stage solves this issue by incorporating a gradient-based approach to refine the solution x_{EXP} into the solution x_{GD} and in the process collect more data that are used to refine the surrogate model's predictions. Specifically, it computes gradient step 501 on the surrogate model to move the solution closer to the Pareto front—the set of all optimal trade-offs between competing objectives. However, since the surrogate model is an approximation, the computed gradients may lack accuracy. To address this, the embodiments integrate 502 the ‘Gradient Information Acquisition’ method to improve the quality of the gradient steps. This enhancement ensures that the gradient-based adjustments are more precise and effectively guide the solution toward x_{GD} that are an actionable setting to operate the industrial machine that promotes optimal performance. As a result, the surrogate model can be more accurately updated 503 to provide the mapping from the optimal operating parameters to the machine outcomes that can then be used in the next iteration of the PGE and EXP stage.

FIG. 5B shows a pseudo-code of an exemplary implementation of the Gradient Descent (GD) Stage according to some embodiments. This GD stage is motivated by the fact that x_{EXP}, while expected to be high in utility, is not specifically designed to be near the Pareto-front. Analogous to single-objective optimization, we will pursue local gradients that are expected to generate a trajectory of x candidates that evolves towards a nearby Pareto-optimal point. We will refer to these gradient-following decision variables as ‘x_{GD}’. We set the initial x_{GD} to be x_{EXP}.

Some embodiments adapt the gradient descent must be adapted for multiple objectives. To that end, some embodiments use of multiple gradient descent algorithm (MGDA) designed for smooth multi-outcome objective functions. While MGDA is provably convergent for white-box optimization problem settings i.e. when gradients of each outcome of ƒ is accessible, it has not been tested in the context of black-box multi-objective optimization (MOO), where gradients are not accessible, and must be estimated. However, MGDA exhibits some theoretical properties that, as demonstrated via experiments, are beneficial in the MOO and/or multi-objective Bayesian optimization (MOBO) context.

MGDA exploits the Karush-Kuhn-Tucker(KKT) conditions

$$α \geq 0 , {1}^{T} α = 1 , {α}^{T} ∇ f ( x ) = 0 , \qquad ( 10 )$$

and recasts this for MOO as a quadratic cost constrained on the probability simplex, that is:

$${min}_{α \geq 0} {‖ {α}^{T} ∇ f ( x ) ‖}^{2} subject to : {1}^{T} α = 1. \qquad ( 11 )$$

A solution to (11) is either: α^{T}∇ƒ(x)=0, in which case the current parameters x are Pareto-optimal, or α^{T}∇ƒ(x)≠0, and α^{T}∇ƒ(x) is a feasible descent direction. Given that (11) is a quadratic cost over linear constraints, some implementations can use the Frank-Wolfe algorithm to efficiently compute optimal solutions.

Solving (11) yields an optimal α with which we can take a gradient step x_{GD}←x_{GD}←ηα^{T}∇ƒ(x_{GD}). However, there are two clear difficulties at this juncture. The first is that this update may yield an x_{GD}∉ [symbol] . To counter this, the GD stops updating when this happens, and stops the local gradient search phase, moving on to the next algorithm iterations with an updated dataset D that contains all the x_{GD} and correspond y_{GD} observed so far.

The second and more debilitating problem is that GD implementations do not have access to gradients of ƒ. To address this problem, GD implementations use a surrogate model \hat{ƒ} which can obtain an estimate of the gradient at any x with μ^{∇}:[= [symbol] [∇\hat{ƒ}(x)]. The gradient step is then

$${x}_{GD} ← {x}_{GD} - η {α}^{T} {μ}^{∇} ( {x}_{G D} ) . \qquad ( 12 )$$

In situations when there is no clear correlation between the uncertainties in ƒ and ∇ƒ, so μ^{∇} could have large uncertainties even near previously observed points. Therefore, these embodiments incorporate techniques that can reduce uncertainty in the posterior of the gradient estimate.

Hence, the embodiments select the best candidate from the EXP stage, x_{EXP}, and set it as the initial candidate for the local gradient search: x_{GD}. The GI acquisition tries to select a subsequent point x′ that will minimize the uncertainty of the gradient at x_{GD} if x′ and its corresponding y′ were known. By considering all nr objective independently distributed, the uncertainty information contained in the covariance matrix Σ^{∇} is formulated using its trace, or A-optimal design, and maximize:

$${\sum }_{i = 1}^{{n}_{f}} 𝔼 [ Tr ( {\sum }_{i}^{∇} ( {x}_{GD} \vert D ) ) - Tr ( {\sum }_{i}^{∇} ( {X}_{GD} \vert D , ( {x}^{′} , {y}^{′} ) ) ) ] , \qquad ( 13 )$$

which, for Gaussian distributions, is equivalent to

$$GI ( {x}^{′} ) = {\sum }_{i = 1}^{{n}_{f}} Tr ( ∇ {k}_{i} ( {x}_{G D} , {X}^{′} ) {𝒦}_{σ}^{- 1} ( {X}^{′} ) ∇ {k}_{i}^{T} ( {x}_{GD} , {X}^{′} ) ) \qquad ( 14 )$$

where X′={X∪x′}. For each gradient-step in n_{GD}, the GI acquisition function is optimized n_{GI} times to reduce gradient uncertainty.

Upon each optimization, the GD evaluates the outcome function to obtain a corresponding y_{GD}, which is appended to the dataset D for subsequent iterations of the algorithm.

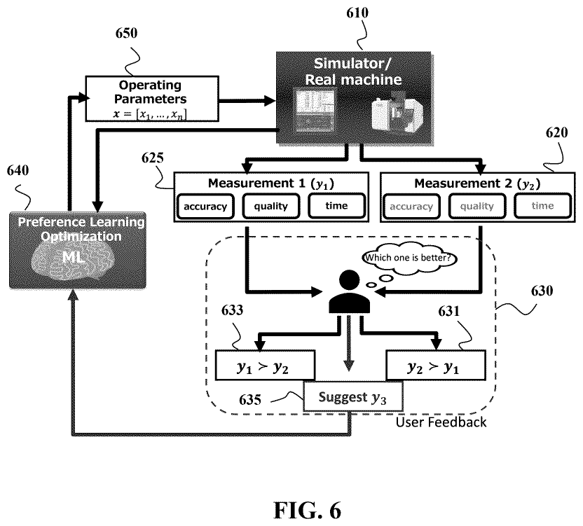

FIG. 6 shows a high-level schematic of a preference-based optimization process for controlling an industrial machine employed by some embodiments using the above-described principles. It highlights the interaction between a machine (or its simulator) and a preference learning optimization framework driven by machine learning (ML).

The Simulator/Real Machine 610 is used by embodiments to generate multiple outputs 620 and 625 such as accuracy, quality, and time in response to specific operating parameters 650. These outputs represent measurable performance metrics that align with user-defined objectives.

The Preference Learning Optimization module 640 leverages machine learning to iteratively learn user preferences and optimize the machine's performance. The preference learning system incorporates user feedback 630 about the generated outcomes to refine models such as the utility model and the preference outcome model.

The user feedback implemented via interface 630 enables the feedback mechanism, where the system presents generated outcomes to the user and collects preferences, including pairwise comparisons and suggestions for improved outcomes. Based on this feedback, the preference learning optimization module updates its internal models to better align with the user's goals.

The user interface allows the user to indicate which of the outcomes, e.g., outcome y₁ 633 or the outcome y₂ 631 is preferred and also allows the user to suggest even better outcome y₃ 635 that is preferred over the outcomes y₁ and y₂. These suggestions are evaluated either through the real machine or a simulator to validate and refine the optimization process.

The entire workflow operates iteratively, continuously learning from user input and refining the operating parameters to improve the machine's performance across conflicting objectives like accuracy, quality, and time. This cycle continues until the system converges on a solution that balances the trade-offs among conflicting objectives while satisfying the user's preferences. The iterative nature ensures continuous improvement, leveraging machine learning to dynamically adapt the machine's performance in response to user input. As a result, a feedback-driven system where a machine's performance is optimized iteratively using machine learning and user preferences, enabling efficient and customized industrial machine control.

### Exemplary Embodiments

One embodiment discloses a method for controlling an industrial machine, comprising: collecting a utility model trained to approximate a utility function defining the utility of an outcome of the industrial machine; collecting a preference outcome model trained to map at least a pair of the outcomes of the industrial machine to another outcome preferred over the outcomes of the pair; generating multiple outcomes by optimizing an acausal coactive acquisition function configured to maximize a joint gain in the utility of the generated outcomes according to the trained utility model and a preference of the generated outcomes according to the trained preference outcome model; determining a desired outcome based on the generated outcomes; mapping the desired outcome to the operating parameters of the industrial machine; and controlling the industrial machine according to the mapped operating parameters.

This method provides a structured approach for controlling an industrial machine by combining two key models: a utility model and a preference outcome model. The utility model approximates the utility of various machine outcomes based on operational objectives, while the preference outcome model identifies user-preferred outcomes among a set of generated options. By employing an acausal coactive acquisition function, the system generates multiple outcomes that maximize a joint gain, integrating both utility and user preferences. The desired outcome is then mapped to the machine's operating parameters, which are adjusted accordingly to achieve optimal performance. This method enhances precision and adaptability, simplifies complex optimization tasks, and ensures machine performance aligns with both technical and user-defined goals, reducing manual intervention and improving overall efficiency.

Additionally or alternatively, one embodiment includes learning user preferences and tuning the operating parameters of the industrial machine based on user feedback from a user interface.

The method is further refined by incorporating user feedback through a user interface, allowing the system to learn user preferences and adjust the machine's operating parameters dynamically. By capturing real-time insights into user priorities, this approach increases the machine's adaptability to diverse operational scenarios, making it responsive to changing requirements. This iterative feedback loop reduces the need for predefined settings and allows the system to self-optimize, streamlining operations and enhancing user satisfaction.

Additionally or alternatively, in one embodiment, learning user preferences comprise: obtaining user feedback on the generated outcomes, wherein the feedback indicates a preference between the outcomes in the pair of generated outcomes and a preferred outcome that is preferred over each of the outcomes in the pair of generated outcomes; training the utility model based on the preference between the outcomes in the pair and based on the preferences of the preferred outcome over each of the outcomes in the pair of generated outcomes provided in the feedback; and training the preference outcome model to map the pair of the generated outcomes to the preferred outcome provided in the user feedback.

User preferences are learned by collecting feedback on generated outcomes, which includes pairwise comparisons and suggested alternatives. This feedback trains the utility model to refine its understanding of operational priorities and the preference outcome model to better predict preferred outcomes. By mapping subjective user preferences to actionable machine settings, this process ensures accurate and user-aligned performance. The iterative refinement of the models improves optimization precision and reduces the gap between expected and actual outcomes, leading to higher-quality results and increased operational efficiency.

Additionally or alternatively, in one embodiment process of learning user preferences and tuning machine parameters is repeated iteratively until a termination condition, such as achieving a desired performance threshold, is met. Each cycle further aligns the machine's performance with user-defined goals. This iterative process ensures continuous improvement, systematically refining machine operations to adapt to dynamic changes in user preferences or operational conditions. By minimizing trial-and-error, it accelerates convergence toward optimal performance while maintaining flexibility for diverse scenarios.

Additionally or alternatively, in one embodiment, the method automates the adjustment of operating parameters between optimization cycles based on the generated outcomes, eliminating the need for manual intervention. By automating this process, the system enhances operational efficiency and reduces user workload, allowing the machine to respond rapidly to feedback and environmental changes. This automation ensures consistent and precise tuning, minimizing errors and downtime.

Additionally or alternatively, in one embodiment, the method ensures that the operating parameters are fine-tuned to lie on the Pareto frontier, representing an optimal trade-off among competing objectives such as speed, quality, and cost. This ensures balanced optimization, where improvements in one metric do not disproportionately degrade others. By aligning performance with real-world constraints, this approach enables the machine to meet complex, multi-objective requirements effectively and consistently.

Additionally or alternatively, in one embodiment, the acausal coactive acquisition function optimizes outcomes by maximizing the difference between the utility of the current model and the utility of the model after being updated with feedback and predicted preferences. This approach prioritizes the most impactful adjustments, focusing the optimization process on outcomes that offer the greatest improvement. By reducing unnecessary iterations, this method accelerates learning and ensures efficient resource utilization, making the process both time- and cost-effective.

Additionally or alternatively, in one embodiment, the optimization occurs in the domain of machine operating parameters, while the preference outcome model operates in the domain of outcomes. The acausal coactive acquisition function bridges these domains using a surrogate model to translate desired outcomes into actionable parameters. This capability resolves mismatches between user-defined goals and machine settings, enabling seamless integration of preferences into operational adjustments. By enhancing precision and usability, this approach ensures that user-defined outcomes are translated effectively into machine behavior.

Additionally or alternatively, in one embodiment, the acausal coactive acquisition function is implemented as a Knowledge-Gradient Coactive Acquisition Function (KGCAF), enabling one-shot optimization. This reduces computational overhead by minimizing the number of iterations required to identify optimal parameter settings. By focusing on the most promising adjustments, the system ensures faster decision-making and improved scalability, making it particularly suited for real-time or high-demand environments.

Additionally or alternatively, in one embodiment, the method includes two distinct stages: a preference-guided exploration (PGE) stage for learning user preferences and an experimentation (EXP) stage for training a surrogate model of the machine. This structured approach combines user-driven exploration with data-driven refinement, reducing uncertainty and improving the accuracy of the optimization process. By balancing immediate performance improvements with long-term model robustness, this method ensures efficient and reliable machine operation across diverse applications.

Additionally or alternatively, in one embodiment, during the EXP stage, machine parameters are determined using a probabilistic acquisition function. The machine is then operated or simulated based on these parameters, and the surrogate model is updated with the observed outcomes. This stage expands the dataset with validated outcomes, improving the model's predictive capability. By integrating experimental validation, this method ensures that the optimization process is grounded in reliable data, resulting in progressively better machine performance.

Additionally or alternatively, in one embodiment, the method includes a gradient descent (GD) stage that refines machine parameters further by computing gradient steps on the surrogate model toward the Pareto frontier. The surrogate model is updated with the new parameters and their corresponding outcomes. This stage fine-tunes machine performance, addressing limitations of earlier iterations and achieving globally optimal solutions. By enabling precise adjustments, this approach ensures that the final results are aligned with the best trade-offs between competing objectives.

Additionally or alternatively, in one embodiment, the gradient descent stage employs multi-objective evolutionary algorithms to explore parameter settings and refine outcomes beyond local optima. This approach avoids premature convergence and identifies diverse high-performing solutions, ensuring flexibility and adaptability. By exploring complex optimization landscapes, it accelerates progress toward achieving the best possible performance.

Additionally or alternatively, in one embodiment, the user feedback is collected through a graphical user interface that dynamically visualizes the generated outcomes and their associated trade-offs. By providing intuitive visual feedback, this interface improves user engagement and clarity in decision-making. It empowers users to make informed adjustments, enhancing the system's usability and effectiveness.

Additionally or alternatively, in one embodiment, the system incorporates voice-based or natural language input processed by a machine learning model to infer user preferences. This makes the feedback process more accessible and user-friendly, especially for non-technical users. By simplifying input requirements, this feature broadens the system's applicability and ensures seamless integration into diverse operational contexts.

### Exemplary Implementations

Various embodiments of this disclosure can be applied in a variety of industrial and commercial settings where complex machines require optimized operation based on conflicting performance objectives and user-specific preferences. Below are some examples of its practical applications.

### CNC Machines in Manufacturing

CNC machines, including milling machines, lathes, and laser cutters, require precise tuning of parameters to balance speed, accuracy, and cost effectively for different production runs. For instance, high-precision aerospace components demand stringent tolerances, while large-scale automotive parts prioritize throughput. This system enables CNC machines to dynamically adjust parameters, such as cutting speeds, tool paths, and feed rates, based on user-defined priorities.

By integrating user feedback into its optimization process, the system iteratively learns preferences, such as favoring product quality over production speed. This reduces the reliance on skilled operators, shortens setup times, and ensures consistent alignment of machine performance with production goals. As a result, manufacturers achieve enhanced efficiency, superior part quality, and adaptability for diverse production requirements.

### Robotics in Automated Assembly Lines

In automated manufacturing environments, robots must balance speed, precision, and energy efficiency for tasks such as assembly, packaging, or inspection. For example, delicate electronic components require precise and careful handling, while packaging operations benefit from high-speed movements. The system fine-tunes robotic parameters, including arm speed, torque, and path planning, to meet these varying requirements.

Through iterative optimization based on user feedback, the system ensures smooth robotic operations with minimal errors. It adapts in real-time to changes in production needs or material properties, reducing downtime caused by manual reprogramming. This flexibility enhances productivity, ensures consistent performance, and reduces the operational burden on engineers.

### HVAC Systems in Smart Buildings

Modern HVAC systems must optimize energy consumption, comfort, and air quality simultaneously, often responding to dynamic factors such as weather conditions or occupancy changes. For example, energy savings might be prioritized during off-peak hours, while consistent air quality is essential in high-traffic areas.

This system learns user preferences over time to optimize settings like airflow, temperature setpoints, and humidity levels dynamically. By reducing energy costs while maintaining occupant comfort, it provides a responsive, efficient solution for managing environmental conditions in smart buildings. The system's adaptability ensures continuous performance optimization even as external factors change.

### Industrial Printing Presses

Industrial printing presses face the challenge of balancing print quality, production speed, and ink usage across various print jobs. For example, premium clients may require color accuracy, while bulk orders demand high throughput with minimal ink wastage. The system dynamically optimizes parameters such as print head speed, ink flow, and pressure settings based on operator feedback.

By minimizing setup errors and refining outcomes iteratively, the system ensures consistent quality across large batches. It reduces material waste, enhances operational efficiency, and provides the flexibility to handle diverse printing requirements seamlessly.

### Semiconductor Manufacturing

Semiconductor fabrication is a complex process that requires balancing precision, production speed, and defect rates to ensure optimal yields. For instance, high-value wafers demand precise control over parameters like etching depth, deposition rate, and lithography exposure. Achieving these requires iterative tuning based on real-time process feedback.

This system fine-tunes these parameters dynamically, learning from user inputs to optimize machine performance. It enhances production efficiency by minimizing defects and reducing the complexity of process tuning for operators. This adaptive approach ensures consistent quality and yields, even in high-precision manufacturing environments.

### Adapting for CNC Machines in Manufacturing

Computer Numerical Control (CNC) machines are foundational to precision manufacturing across industries such as automotive, aerospace, and electronics. They must navigate conflicting objectives like balancing speed, accuracy, tool wear, and cost while accommodating customer-specific requirements. This CNC embodiment offers a user-centric, adaptive optimization framework that revolutionizes CNC operations. By iteratively refining machine settings based on user feedback, the system dynamically adjusts parameters to ensure optimal performance tailored to operational goals and individual preferences.

The CNC embodiment applies a series of powerful tools to address CNC challenges. The utility model quantifies the value of outcomes, such as surface finish or cycle time, enabling operators to prioritize objectives. For example, aerospace parts may demand precision over speed, while bulk production of simpler parts may emphasize efficiency. The preference outcome model maps user feedback, like “reduce chatter marks,” to actionable adjustments in spindle speed or feed rate, ensuring nuanced preferences guide the process. A surrogate model further enhances efficiency by predicting outcomes like vibrations or tool wear, eliminating the need for exhaustive trials. Finally, the acausal coactive acquisition function (e.g., KGCAF) balances exploration of new settings with refinement of known preferences, accelerating convergence toward optimal solutions.

The system's workflow begins with training models using historical data and defining operational constraints. For a new job, initial parameters are generated based on user-defined priorities. After machining the first batch, operators provide feedback, including pairwise comparisons and suggestions. Models are then updated to predict better settings, and parameters are iteratively refined in subsequent batches until optimal trade-offs are achieved. The final stage involves fine-tuning settings using gradient descent techniques to align with the Pareto frontier, ensuring the best balance of speed, cost, and quality. Optimized parameters and models are saved for future jobs, enabling faster setup and improved consistency.

This method provides key benefits for CNC operations. It dynamically customizes parameters for unique requirements without extensive operator involvement, reducing setup time and tool wear through predictive modeling. Cost savings are achieved by minimizing material waste and optimizing energy use, while repeatable quality is ensured through iterative learning. The system's scalability makes it adaptable to different machines and materials, creating a versatile solution for diverse manufacturing needs.

Practical applications include machining high-precision aerospace components where the system refines spindle speeds to achieve tight tolerances. In mass production, such as automotive parts, it optimizes feed rates and tool paths to maximize throughput and tool longevity. For custom prototyping, the system quickly adapts to varying specifications, balancing speed and accuracy to meet dynamic demands. Seamlessly integrating into existing CNC software and leveraging real-time hardware sensors for feedback, this system transforms CNC machining into an efficient, user-driven process that aligns with both operational and business goals.

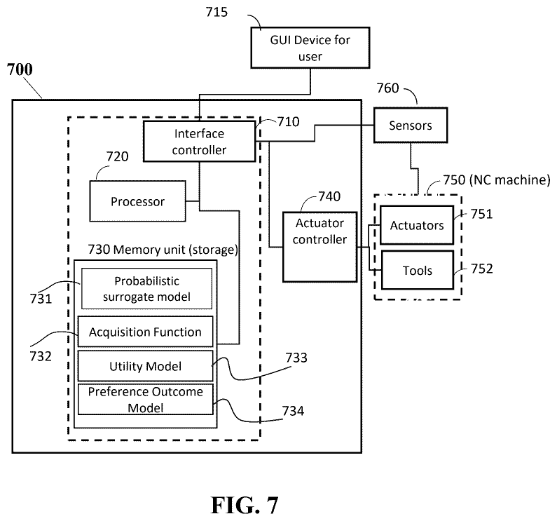

FIG. 7 shows a block diagram illustrating a CNC control system 700 for controlling motions of a NC machine 750 according to embodiments of the present disclosure. The CNC control system 700 is configured to control an actuator system 751 and/or tools 752 of the NC machine 750 of the robot by submitting operating parameters, such as motion trajectory of a milling tool, to the actuator controller 740.

The CNC control system 700 includes a memory 730 storing various models of the system. The models include, a surrogate model 731 of the NC machine, an acquisition function(s) 732. The utility model 733 and the preference outcome model 734. The memory also can store executable code for training and using the models 731-734.

The CNC control system 700 may include an interface controller 710, a processor 720, and a memory unit 730. The processor 720 may be one or more than one processor units, and the memory unit 730 may be memory devices, a data storage device or the like. The interface controller 710 can be an interface circuit, which may include analogue/digital (A/D) and digital/analogue (D/A) converters to make signal/data communication with sensors 760 and a controller 740 of the NC machine. Further, the interface controller 710 may include a memory to store data to be used by the A/D or D/A converters. The sensors 760 are arranged to measure the stats of the NC machine. The CNC control system 700 can also be connected to user interface 715 for providing user feedback and preferences.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. The term “based on” means at least partially based on. Further, it is to be understood that the phraseology and terminology employed herein are for the purpose of description and should not be regarded as limiting unless specifically defined as a limitation. Any heading utilized within this description is for convenience only and has no legal or limiting effect.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

1. A method for controlling an industrial machine, wherein the method uses a processor coupled with stored instructions implementing the method, wherein the instructions, when executed by the processor carry out steps of the method, comprising:
collecting a utility model trained to approximate a utility function defining utility of an outcome of the industrial machine;
collecting a preference outcome model trained to map at least a pair of the outcomes of the industrial machine to another outcome preferred over the outcomes of the pair;
generating multiple outcomes by optimizing an acausal coactive acquisition function configured to maximize a joint gain in the utility of the generated outcomes according to the trained utility model and a preference of the generated outcomes according to the trained preference outcome model;
determining a desired outcome based on the generated outcomes;
determining operating parameters of the industrial machine corresponding to the desired outcome; and
controlling the industrial machine according to the operating parameters.

2. The method of claim 1, further comprising:
learning user preferences and tuning the operating parameters of the industrial machine based on user feedback from a user interface.

3. The method of claim 2, wherein learning user preferences comprises:
obtaining user feedback on the generated outcomes, wherein the feedback indicates a preference between the outcomes in the pair of generated outcomes and a preferred outcome that is preferred over each of the outcomes in the pair of generated outcomes;
training the utility model based on the preference between the outcomes in the pair and based on the preferences of the preferred outcome over each of the outcomes in the pair of generated outcomes provided in the feedback; and
training the preference outcome model to map the pair of the generated outcomes to the preferred outcome provided in the user feedback.

4. The method of claim 3, further comprising:
iteratively repeating learning user preferences and tuning the operating parameters in successive cycles until a termination condition is met to update the models and generate outcomes that progressively align with the learned user preferences.

5. The method of claim 4, wherein the operating parameters are adjusted automatically between cycles based on the generated outcomes.

6. The method of claim 5, wherein the operating parameters are adjusted approach a Pareto frontier of performance objectives of the industrial machine.

7. The method of claim 1, wherein the acausal coactive acquisition function returns the utility of the pair of outcomes maximizing a difference between the utility of a current utility model and the utility of the utility model tuned based on the utility of a candidate pair of outcomes and a prediction of the preferred outcome given by the preference outcome model.

8. The method of claim 1, wherein the acausal coactive acquisition function performs the optimization in a domain of the operating parameters of the industrial machine, while the preference outcome model operates in a domain of the outcomes of the industrial machine, and wherein the acausal coactive acquisition function transforms the operating parameters into the domain of the outcomes using a surrogate model of the industrial machine.

9. The method of claim 1, wherein the acausal coactive acquisition function is implemented as a knowledge-gradient co-active acquisition function (KGCAF) that enables one-shot optimization.

10. The method of claim 1, wherein an iteration of the method includes a preference-guided exploration (PGE) stage for learning user preferences for the desired outcome and an experimentation (EXP) stage for finding the optimal operating parameters and training a surrogate model of the industrial machine utilized in the PGE stage.

11. The method of claim 10, wherein the EXP stage comprises:
determining EXP operating parameters of the machine using a probabilistic acquisition function employing the utility model;
performing one or a combination of simulating or operating the industrial machine according to the EXP operating parameters to produce an EXP outcome of the machine operated according to the EXP operating parameters; and
training the surrogate model of the machine using a pair of the EXP operating parameters and the EXP outcome.

12. The method of claim 11, wherein the iteration of the method further includes a gradient descent (GD) stage, the GD stage comprising:
determining GD operating parameters of the industrial machine by computing a gradient step from the EXP operating parameters on the surrogate model toward a Pareto frontier of the operating parameters;
updating the gradient step from the EXP operating parameters using a gradient information acquisition method to produce GD operating parameters; and
updating the surrogate model with the GD operating parameters computed and outcome of the industrial machine operating according to the GD operating parameters.

13. The method of claim 12, wherein the GD stage employs multi-objective evolutionary algorithms to refine operating parameters beyond local optima.

14. The method of claim 3, wherein the user feedback is collected through a graphical user interface that dynamically visualizes the generated outcomes and their trade-offs.

15. The method of claim 3, wherein the user feedback includes voice-based or natural language input processed by a machine learning model to infer preferences.

16. The method of claim 1, wherein the industrial machine is a Computer Numerical Control (CNC) machine.

17. A system for controlling an industrial machine, comprising: a processor; and a memory having instructions stored thereon that, when executed by the processor, cause the system to:
collect a utility model trained to approximate a utility function defining the utility of an outcome of the industrial machine;
collect a preference outcome model trained to map at least a pair of the outcomes of the industrial machine to another outcome preferred over the outcomes of the pair;
generate multiple outcomes by optimizing an acausal coactive acquisition function configured to maximize a joint gain in the utility of the generated outcomes according to the trained utility model and a preference of the generated outcomes according to the trained preference outcome model;
determine a desired outcome based on the generated outcomes;
determine optimal operating parameters of the industrial machine by optimizing an acquisition function based on the utility model and on a surrogate model of the industrial machine; and
control the industrial machine according to the optimal operating parameters.

18. The system of claim 17, further comprising:
a user interface configured to obtain a feedback on the generated outcomes, wherein the feedback indicates a preference between the outcomes in the pair of generated outcomes and a preferred outcome that is preferred over each of the outcomes in the pair of generated outcomes; and
a training executable code configured for training the utility model based on the preference between the outcomes in the pair and based on the preferences of the preferred outcome over each of the outcomes in the pair of generated outcomes provided in the feedback; and training the preference outcome model to map the pair of the generated outcomes to the preferred outcome provided in the user feedback.

19. The system of claim 18, wherein the acausal coactive acquisition function returns the utility of the pair of outcomes maximizing a difference between the utility of the current utility model and the utility of the utility model tuned based on the utility of the pair of outcomes and a prediction of the preferred outcome given by the preference outcome model.

20. A non-transitory computer-readable storage medium embodied thereon a program executable by a processor for performing a method for perceiving an object in a scene, the method comprising:
collecting a utility model trained to approximate a utility function defining the utility of an outcome of an industrial machine;
collecting a preference outcome model trained to map at least a pair of the outcomes of the industrial machine to another outcome preferred over the outcomes of the pair;
generating multiple outcomes by optimizing an acausal coactive acquisition function configured to maximize a joint gain in the utility of the generated outcomes according to the trained utility model and a preference of the generated outcomes according to the trained preference outcome model;
determining a desired outcome based on the generated outcomes;
determining operating parameters of the industrial machine corresponding to the desired outcome; and
controlling the industrial machine according to the mapped operating parameters.
